(19) United States
(12) Patent Application Publication
(10) Pub. No.: US 2022/0176794 A1
(43) Pub. Date: Jun. 9, 2022

(54) Hybrid Transmission Device and Motor Vehicle

(71) Applicant: ZF Friedrichshafen AG, Friedrichshafen (DE)

(72) Inventors: Stefan Beck, Eriskirch (DE); Johannes Kaltenbach, Friedrichshafen (DE); Matthias Horn, Tettnang (DE); Michael Wechs, Weißensberg (DE); Thomas Martin, Weissensberg (DE); Martin Brehmer, Tettnang (DE); Fabian Kutter, Kressbronn (DE); Peter Ziemer, Tettnang (DE); Oliver Bayer, Hörbranz (AT); Thomas Kroh, Lindau (DE); Max Bachmann, Friedrichshafen (DE)

(21) Appl. No.: 17/602,925

(22) PCT Filed: Mar. 3, 2020
(86) PCT No.: PCT/EP2020/055530

§ 371 Date: Oct. 11, 2021

(30) Foreign Application Priority Data
Apr. 12, 2019 (DE) 10 2019 205 324.6

(51) Int. Cl. B60K 6/36; B60K 6/40; B60K 6/48; B60K 6/547; B60K 6/52; F16H 3/089

(52) U.S. Cl. CPC B60K 6/36; B60K 6/40; B60K 6/48; B60K 6/547; F16H 2003/007; F16H 3/089; B60K 2006/4825; B60K 2006/4833; B60K 6/52

(57) ABSTRACT

A hybrid transmission device (3, 56, 60, 64) may include a first transmission input shaft (12), a second transmission input shaft (14) mounted on the first transmission input shaft, at least one drive device (EM2), and precisely one connecting clutch (K3). Particularly, the connecting clutch (K3) may selectively rotationally fix the first transmission input shaft (12) to the second transmission input shaft (14).

### CROSS-REFERENCE TO RELATED APPLICATION

The present application is related and has right of priority to German Patent Application No. 10 2019 205 324.6 filed on Apr. 12, 2019 and is a nationalization of PCT/EP2020/055530 filed in the European Patent Office on Mar. 3, 2020, both of which are incorporated by reference in their entirety for all purposes.

### FIELD OF THE INVENTION

The invention relates generally to a hybrid transmission device with a first transmission input shaft, a second transmission input shaft mounted on the first transmission input shaft, at least one electric motor, and a connecting clutch for the rotationally fixed connection of the first transmission input shaft and the second transmission input shaft, where the first transmission input shaft is connected to the output of a clutch for connection to an internal combustion engine.

### BACKGROUND

It is known to utilize hybrid transmission devices to reduce the CO2 emissions of motor vehicles. A hybrid transmission device is understood to be a transmission device with which an internal combustion engine and at least one further drive device are couplable. It is known to hybridize all automated transmissions, for example, automatic transmissions and dual clutch transmissions. DE10 2011 005 451 A1 describes a transmission, which includes two electric motors and is capable of providing five forward gears and one reverse gear.

### SUMMARY OF THE INVENTION

An example aspect of the present invention is a hybrid transmission device, which is compact for front-mounted transverse applications and offers the possibility to obtain multiple embodiments with a small number of components.

The hybrid transmission device has precisely one clutch, which is a connecting clutch for the rotationally fixed connection of the first transmission input shaft and the second transmission input shaft.

The transmission of the hybrid transmission device is advantageously a gear change transmission, having at least two discrete gear steps.

Advantageously, the gear change transmission includes at least two sub-transmissions, preferably precisely two sub-transmissions. This allows for increased functionality and, for example, tractive force support during a gear change, particularly an internal-combustion-engine gear change as well as an electric gear change.

Preferably, at least one of the sub-transmissions is a gear change transmission. In particular, two or more sub-transmissions, preferably precisely two sub-transmissions, are gear change transmissions. The sub-transmissions have at least two gear steps.

Advantageously, all, sub-transmissions have an identical number of gear steps. Preferably, the sub-transmissions have precisely two gear steps. Due to the symmetrical distribution of the gear steps, the even and odd gears are easily interchanged between the sub-transmissions without the need to change the arrangement of the engagement devices.

Advantageously, the gear change transmission includes gearwheels and shift elements. The gearwheels are preferably spur gears.

Preferably, the transmission of the hybrid transmission device is a stationary transmission. In stationary transmissions, the axes of all gearwheels in the transmission are fixed in relation to the transmission housing.

Preferably, the gear change transmission is a countershaft transmission. Preferably, the gear change transmission is a spur gear drive. The gearwheels are spur gears in this case.

In addition, the transmission preferably includes at least two transmission input shafts. Preferably, the transmission includes precisely two transmission input shafts. With three or more transmission input shafts, although a larger number of sub-transmissions is produced, it has been proven that the described functionality is already achieved with two transmission input shafts.

Preferably, the first transmission input shaft is a solid shaft. Regardless of the first transmission input shaft, the second input shaft is preferably mounted on the first transmission input shaft, i.e., it is arranged coaxially thereto and encloses the first transmission input shaft. The second input shaft is a hollow shaft.

Preferably, the hybrid transmission device includes at least one countershaft, preferably precisely one countershaft. In the case that a single countershaft is utilized, a single point of connection to the differential is present. As a result, installation space is saved in the radial direction as well as in the axial direction.

Therefore, the transmission in one preferred embodiment includes precisely three shafts, namely two transmission input shafts and one countershaft, where the countershaft is also the output shaft.

In an all-wheel variant of the transmission, one shaft is always added, which drives the second motor vehicle axle, as a power take-off.

A gear step, is a ratio between two shafts that is mechanically implemented with gearwheels. The overall gear ratio between the internal combustion engine or the drive device and the wheel has further ratios, wherein the ratios upstream from a gear step, the so-called “pre-ratios,” depend on the input that is utilized. The “post-ratios” are usually identical. In an embodiment shown further below, in a pre-ratio, the rotational speed and the torque of a drive device are transmitted multiple times, namely by at least one gearwheel pair between the output shaft of the drive device and a transmission input shaft. The pre-ratio is followed by a gearwheel pair of a gear step with a ratio dependent on the gear step, which is followed by a gearwheel pair between the countershaft and the differential, as a post-ratio. A gear has an overall gear ratio that depends on the input and the gear step. Unless indicated otherwise, a gear relates to the utilized gear step.

Merely for the sake of clarity, it is pointed out that the ascending numbers of the gear steps refer, as usual, to a descending ratio. A first gear step has a higher ratio than a second gear step, etc.

If torque is transmitted from the internal combustion engine via the first gear step, this is referred to as an internal-combustion-engine gear. If the second drive device and the internal combustion engine simultaneously transmit torque via the first gear step, this is referred to as a hybrid gear. If only the second drive device transmits torque via the first gear step, this is referred to as an electric gear.

Preferably, the transmission of the hybrid transmission device has at least three gear steps or gear stages. The gearwheels of a gear step are arranged in a gear plane when the gear step includes two gear-step gears. Preferably, the transmission has at least four gear steps or gear stages. Preferably, the transmission has precisely four gear steps.

Preferably, the transmission of the hybrid transmission device has one gear plane more than gear steps. For example, in the case of four gears, there are five gear planes. The gear plane for connecting the drive output, for example, a differential, is included in the count.

Preferably, all gear steps of one of the sub-transmissions are utilized in an internal combustion engine-driven and electrical or fluidic manner. As a result, a maximum number of gears is obtained at a low number of gear steps. In particular, exclusively one sub-transmission is electrically or fluidically utilized in order to obtain a hybrid operation, as further connections between the sub-transmissions or a second drive device primarily increase necessary installation space.

Advantageously, the hybrid transmission device and/or the transmission is free from or without a reversing gearwheel for reversing the direction. Therefore, the reverse gear is not produced via the internal combustion engine, but rather via the drive device or at least one of the drive devices. In this case, for example, the first gear step or the second gear step is utilized.

Preferably, in a first alternative, gear-step gearwheels for all even gear steps are arranged on the first transmission input shaft. In addition, gear-step gears of all odd gear steps are preferably arranged at the second transmission input shaft. Gear-step gears, which are also referred to as gear-step gearwheels, are fixed gears or idler gears. They are referred to as gear-step gears because they are associated with a gear step.

In a second alternative, gear-step gearwheels for all odd gear steps are arranged on the first transmission input shaft and gear-step gearwheels for all even gear steps are arranged on the second transmission input shaft. The even and odd gears are easily interchanged between the sub-transmissions without problem given a symmetrical arrangement of the gear steps.

Preferably, the highest even gear step and/or one of the gear-step gears associated with the highest even gear step are/is located at the axial end of the transmission input shaft that supports one of the gear-step gearwheels of the highest even gear step. Preferably, the highest even gear step is the fourth gear step and/or the transmission input shaft is the second transmission input shaft. Alternatively, the transmission input shaft is the first transmission input shaft.

Preferably, the highest odd gear step and/or one of the gear-step gears associated therewith are/is located at the axial end of the transmission input shaft that supports one of the gear-step gearwheels of the highest odd gear step. Preferably, the highest odd gear step is the third gear step and/or the transmission input shaft is the first transmission input shaft. Alternatively, the transmission input shaft is the second transmission input shaft.

In a first embodiment, in sum, the gear-step gearwheels of the highest gear steps is located at the axial outer sides of the shafts, in particular of the transmission input shafts. If the transmission has four gear steps, the fourth gear step and the third gear step, i.e., the gearwheels thereof, are arranged axially externally and the other gear steps and their gearwheels are arranged within these two gear steps.

Preferably, the gear-step gears of the fourth gear step and of the second gear step are arranged from the outer side of the hybrid transmission device toward the inner side on the second transmission input shaft.

Alternatively, the gear-step gears of the third gear step and of the first gear step are arranged from the outer side of the hybrid transmission device toward the inner side on the second transmission input shaft.

Preferably, the gear-step gears of the third gear step and of the first gear step are arranged from the outer side of the hybrid transmission device toward the inner side on the first transmission input shaft.

Alternatively, the gear-step gears of the fourth gear step and of the second gear step are arranged from the outer side of the hybrid transmission device toward the inner side on the first transmission input shaft.

Preferably, the hybrid transmission device includes precisely one drive device. An arrangement of one or multiple drive device(s) that act(s) at a certain point of the hybrid transmission device also counts as a drive device. This means, for example, in an embodiment of the drive device as an electric motor, that multiple small electric motors are also considered to be a single electric motor if their torque is combined at a single starting point.

Advantageously, the drive device is associated with the second transmission input shaft. The gears implemented via the first transmission input shaft and the gears implemented via the second transmission input shaft form a sub-transmission in each case. It may therefore also be stated that a drive device is associated with the second sub-transmission. Preferably, the hybrid transmission device includes precisely two sub-transmissions.

Preferably, the drive device is also a generator. The drive device is then both a motor and a generator.

Preferably, the drive device is connected to the highest gear step of the transmission. Alternatively, the drive device is connected to the second-highest gear stage of the transmission. In other words, the drive device is connected to the highest gear stage of the sub-transmission at which it acts.

Preferably, the drive device is connected to an axially externally situated gear step, more precisely, to one of the gearwheels of the gear step of the transmission.

At this point, it is to be pointed out that, in the present invention, a connection or operative connection refers to any power flow-related connection, also across other components of the transmission. A connection, however, refers to the first connecting point for transmitting drive torque between the prime mover and the transmission.

A connection to a gear step, i.e., one of its gear-step gearwheels, takes place via a gearwheel. An additional intermediate gear may be necessary, in order to bridge the center distance between the output shaft of the drive device and the transmission input shaft. Alternatively, a chain is also utilized for the connection. Due to the connection of the drive device to a gear-step gearwheel, a further gear plane is avoided, which would be present only for the connection of the drive device.

Advantageously, at least one of the axially external gear-step gears, which are arranged on the axis of the transmission input shafts, is a fixed gear. Preferably, both axially external gear-step gears are fixed gears. The drive device is therefore preferably in a so-called “P3 arrangement,” i.e., at the transmission gear set.

Preferably, one drive device is connected to the third gear stage.

Alternatively, a drive device is connected to the fourth gear stage.

Preferably, the drive device is utilized for an electric or fluidic forward starting operation. In this case, the second drive device is coupled, advantageously, to the gear-step gears of the second gear step or the first gear step. The starting operation is always performed by the drive device. The drive device is preferably utilized as a sole drive source for the starting operation. Similarly, the drive device is utilized for electric or fluidic travel in reverse. Preferably, it is also provided here that the drive device is the sole drive source during travel in reverse. In this case, there are no internal-combustion-engine or hybrid reverse gears.

Preferably, the drive device is axially parallel to the first transmission input shaft. It is then preferably also axially parallel to the second transmission input shaft and to the countershaft. According to example aspects of the present invention, an axially parallel arrangement refers not only to completely parallel arrangements. An inclination or an angle between the longitudinal axis of the transmission input shafts and the longitudinal axis of the electric motor is also present. Preferably, an angle is provided between the longitudinal axis of an electric motor and the longitudinal axis of the transmission input shafts of less than or equal to 10°, further preferably less than 5° and, preferably 0°. Slight inclinations of the drive devices in comparison to the transmission result for reasons related to installation space.

Alternatively, the drive device is coaxial to the first transmission input shaft. The drive device is then advantageously connected to the second transmission input shaft. Further, in the axial direction, the drive device is then preferably situated between the connecting clutch and the first gearwheel on the second transmission input shaft, i.e., axially externally. In particular, the drive device is situated in the axial direction at the same level as the gear plane of the differential.

Preferably, the axis of the drive device—given an axially parallel arrangement of the drive device—in the installation position is situated above the axis of the transmission input shaft. The installation position is always referenced in the following. During installation, the hybrid transmission device is also able to be upside down. Such positions are irrelevant for the following description, however. While the axially parallel arrangement also makes it possible for the drive device to be located below the axis of the transmission input shaft, it is advantageously provided that the drive device and, thereby, its axis, is positioned above the transmission input shaft. In this arrangement, the packing density is maximized.

Preferably, the axis of the drive device in the installation position is situated above the axes of one or multiple countershaft(s) and/or one or multiple output shaft(s). The drive device is therefore situated above the aforementioned components of the spur gear drive arrangement. Alternatively, the axis of the drive device in the installation position is the uppermost axis of the hybrid transmission device.

The drive device is preferably at the same level as the gear change transmission in the axial direction. Preferably, the overlap in the axial direction is more than 75%. Advantageously, the overlap in the axial direction is 100%. Here, the overlap is ascertained on the basis of the housing of the drive device. The output shaft of the drive device is not taken into account.

Advantageously, the second drive device is rotationally fixed to the second transmission input shaft, in particular attached to the second transmission input shaft. When the second transmission input shaft is arranged in such a way that it is connectable to the internal combustion engine by a clutch and, in particular, via the first transmission input shaft, the second drive device is utilized in many operating situations as a parallel drive source with respect to the internal combustion engine.

Advantageously, the first transmission input shaft is directly connectable or connected to an internal combustion engine. Directly connected refers to a clutch-free connection. A damping device is present, for example, between the crankshaft and the first transmission input shaft. The damping device includes a torsion damper and/or a damper and/or a slipping clutch. The torsion damper is a dual-mass flywheel. The damper is a rotational speed-adaptive damper.

In principle, two drive devices are provided, wherein preferably each one acts at one of the sub-transmissions.

Preferably, the first drive device and/or the second drive device is an electric motor. Electric motors are widespread in hybrid transmission devices.

Alternatively, or additionally, the first drive device and/or the second drive device is a fluid power machine. In addition to electric motors, there are other prime movers, the utilization of which in hybrid transmission devices is conceivable. These prime movers are also operated as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Even though the hybrid transmission device includes only one single drive device, the transmission is advantageously power-shifted. A powershift is understood, as usual, to mean that no interruption of tractive force occurs at the output of the hybrid transmission device during a gear change, for example, of the drive device. A reduction of the torque present at the output is possible, but a complete interruption is not. The support takes place via the internal combustion engine or an electric axle.

As a result, the motor vehicle is continuously driven in large speed ranges, for example, exclusively electrically, wherein the ratio, i.e., the gear, is selected in each case to be optimized with respect to the rotational speed and torque of the drive device.

Advantageously, the drive device is operatively connected to a differential via, at most, four meshing points. As a result, good efficiency is achieved.

The connecting clutch is utilized for coupling the sub-transmission. However, it is also a clutch for connecting the second transmission input shaft to the internal combustion engine, wherein the connection extends via the first transmission input shaft.

Preferably, the connecting clutch is at the end facing the outer side, in particular the side of the internal combustion engine, of the second transmission input shaft.

In the present invention, an engagement device is an arrangement with one or two shift element(s). The engagement device is one-sided or two-sided. A shift element is a clutch or a gearshift clutch. A clutch is utilized for selectively connecting two shafts in a rotationally fixed manner and a gearshift clutch is utilized for selectively, rotationally fixing a shaft to a hub rotatably mounted thereon, for example, an idler gear. The connecting clutch is a gearshift clutch and is referred to as a clutch simply because it connects two shafts to each other.

Preferably, at least a portion of the clutches and/or gearshift clutches are dog clutches. In particular example embodiments, all clutches and gearshift clutches are dog clutches.

Preferably, the first transmission input shaft in a first embodiment is engagement device-free and/or idler gear-free. Fixed gears, exclusively, are on the first transmission input shaft as gearwheels. Preferably, precisely two fixed gears are arranged on the first transmission input shaft.

Alternatively, idler gears, exclusively, are on the first transmission input shaft as gearwheels. Preferably, precisely two idler gears are on the first transmission input shaft. At least one engagement device is then arranged on the first transmission input shaft. Preferably, at least two, in particular embodiments, precisely two, engagement devices are on the first transmission input shaft. A one-sided engagement device and a two-sided engagement device are provided.

Advantageously, the second transmission input shaft is engagement device-free and/or idler gear-free. Preferably, at least one fixed gear is on the second transmission input shaft. In particular, at least two, preferably precisely two, fixed gears are on the second transmission input shaft.

Advantageously, one fixed gear and one idler gear are associated with each gear step and, in fact, a single fixed gear and a single idler gear in each case. In addition, each fixed gear and idler gear are always unambiguously associated with a single gear step, i.e., there are no winding-path gears by utilizing one gearwheel for multiple gears. Nevertheless, the second and fourth internal-combustion-engine gears or the first and third internal-combustion-engine gears are considered to be winding-path or coupling gears, as described below, depending on the embodiment, since the first transmission input shaft is interconnected during the formation of the gears.

In one preferred embodiment, the hybrid transmission device and/or the transmission includes precisely two two-sided engagement devices for producing four internal-combustion-engine gear stages.

Preferably, a differential is at the level of a clutch for connecting the transmission input shafts in the axial direction. Advantageously, a gearwheel for connecting the differential is axially externally on a countershaft. The connection preferably takes place at the side of the internal combustion engine.

Preferably, the hybrid transmission device includes at least one countershaft, preferably precisely one countershaft. When a single countershaft is utilized, a single point of connection to the differential is present. As a result, installation space is saved in the radial direction as well as in the axial direction.

Preferably, at least one engagement device is on the countershaft. In a first alternative, precisely one engagement device is on the countershaft. Preferably, precisely two idler gears and two fixed gear-step gears are then arranged on the countershaft. In a second alternative, at least two, preferably precisely two, engagement devices are on the countershaft. In addition, advantageously, precisely four idler gears are on the countershaft. Advantageously, all the engagement devices on the countershaft are two-sided.

Preferably, all shift elements of the engagement devices on the countershaft are gearshift clutches.

Preferably, a fixed gear for establishing a connection to the differential is located on the countershaft.

In addition, the hybrid transmission device includes a control device for controlling the transmission as described.

In addition, the invention relates to a hybrid drive train including a hybrid transmission device and at least one electric axle, in particular a rear axle. The hybrid drive train is distinguished by the fact that the hybrid transmission device has a single drive device in the hybrid transmission device. An electric axle is an axle having an electric motor associated therewith. The output of drive torque by the electric motor of the electric axle therefore first takes place in the power flow independently of the hybrid transmission device. Preferably, the electric axle is an assembly unit. The assembly unit also includes a separate transmission, preferably a gear change transmission, for multiplying the drive torque of the electric motor of the electric axle.

During the utilization of an electric axle, the electric axle supports the drive torque when the drive device or the internal combustion engine changes the gear step. The hybrid transmission device is preferably associated with one other than the electric axle.

The invention also relates to a motor vehicle with an internal combustion engine and a hybrid transmission device or a hybrid drive train. The motor vehicle is distinguished by having the hybrid transmission device or the hybrid drive train described.

Advantageously, the hybrid transmission device is arranged in the motor vehicle as a front-mounted transverse transmission device.

Preferably, the motor vehicle includes a control device for the open-loop control of the hybrid transmission device. The control device is therefore part of the hybrid transmission device, although it does not need to be.

Preferably, a battery is arranged in the motor vehicle, which allows for an electric operation of the motor vehicle for at least 15 minutes. Alternatively, for a purely electric operation, the internal combustion engine, with one of the electric motors as a generator, generates current, which goes directly to the other electric motor.

In addition, the motor vehicle includes a pressure reservoir for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle,

FIG. 2 shows a first example gear set scheme,

FIG. 3 shows a first example gear shift matrix,

FIG. 4 shows a second example gear shift matrix,

FIG. 5 shows a second example gear set scheme,

FIG. 6 shows a third example gear shift matrix,

FIG. 7 shows a fourth example gear shift matrix,

FIG. 8 shows a third example gear set scheme, and

FIG. 9 shows a fourth example gear set scheme.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

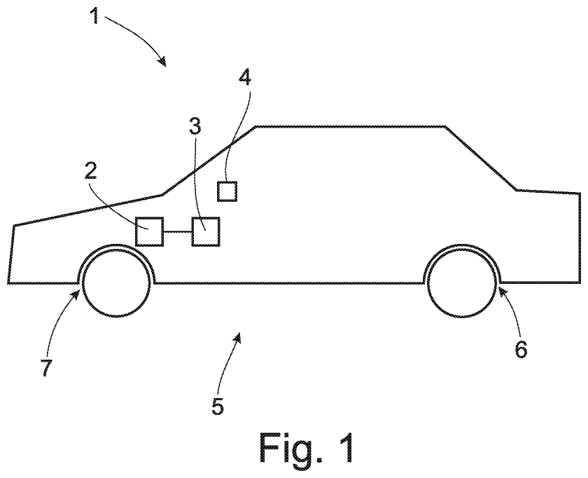

FIG. 1 shows a motor vehicle 1 with an internal combustion engine 2 and a hybrid transmission device 3. The hybrid transmission device 3 also includes, as described in greater detail further below, an electric motor EM2, and so the hybrid transmission device 3 is installed as an assembly unit. This is not absolutely necessary, however. In principle, the gear set forms an assembly unit even without electric motor EM2 already connected. A control device 4 is provided for the open-loop control of the hybrid transmission device 3. This is part of the hybrid transmission device 3 or of the motor vehicle 1.

The hybrid drive train 5 also includes, in addition to the internal combustion engine 2 and the hybrid transmission device 3, at least one electric axle 6. The electric axle 6 is preferably the rear axle when the hybrid transmission device 3 is arranged as a front-mounted transverse transmission and drives the front axle 7, and vice versa.

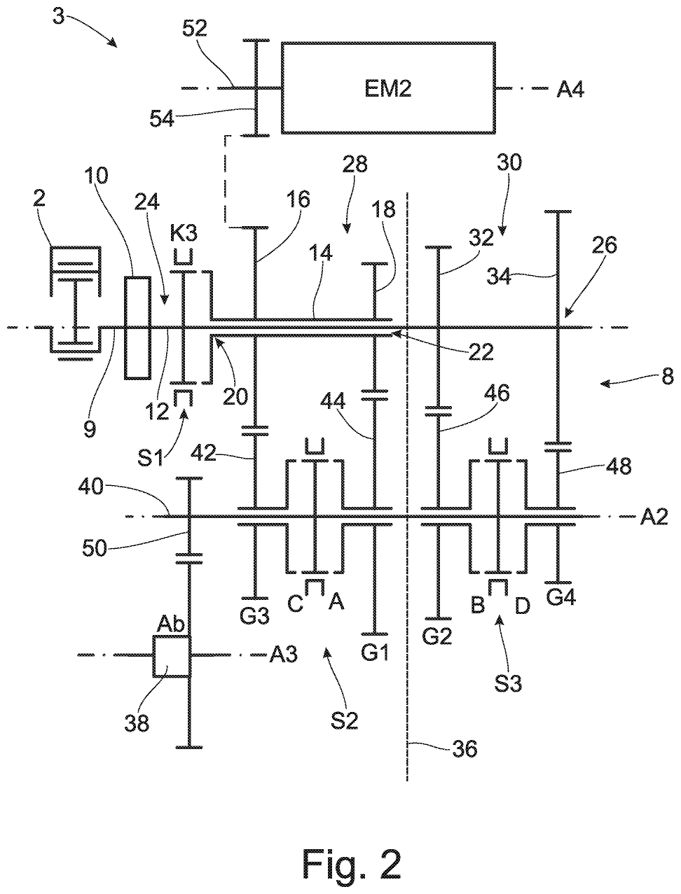

FIG. 2 shows the hybrid transmission device 3 and, in particular, a gear set scheme of its gear change transmission 8. In the following, the hybrid transmission device 3 will be described starting from the internal combustion engine 2. The crankshaft 9 is connected to the first transmission input shaft 12 via a damping device 10. The damping device 10 includes a torsion damper and/or a damper and/or a slipping clutch. A second transmission input shaft 14 is mounted on the first transmission input shaft 12. The connecting clutch K3 is provided as an engagement device S1 in order to connect the first transmission input shaft 12 to the second transmission input shaft 14. The connecting clutch K3 is arranged on the side of the internal combustion engine 2 and axially externally on the first transmission input shaft 12.

A fixed gear 16 of the third gear step G3 and a fixed gear 18 of the first gear step G1 are arranged on the second transmission input shaft 14.

The first transmission input shaft 12 has an input end 24 facing the engine and an output end 26 facing away from the engine, wherein reference is made here to the position in comparison to the internal combustion engine 2. The second transmission input shaft 14 has two ends, namely a first end 20 facing the outer side of the hybrid transmission device 3, closer to the internal combustion engine 2, and a second end 22 facing the inner side of the hybrid transmission device 3, further from the internal combustion engine 2.

A connecting clutch K3 connects the sub-transmissions 28, 30 of the transmission 3. A fixed gear 32 of the second gear step G2 and a fixed gear 34 of the fourth gear step G4 are arranged on the first transmission input shaft. Due to the even number of gears, the gears are mirrored about an axis of symmetry 36 between the sub-transmissions 28 and 30, as will subsequently become apparent. As will be described in grater detail below, the sub-transmissions together have four gear steps, including a first gear step G1, a second gear step G2, a third gear step G3, and a fourth gear step G4. The gear-step gearwheels 16, 34 of the highest gear steps G3, G4 are located axially externally on the axis A1 of the transmission input shafts 12, 14. The gear steps G1 and G2 are arranged axially internally, however.

The second transmission input shaft 14 is shift element-free and idler gear-free. The first transmission input shaft 12 is also idler gear-free. However, an engagement device S1 is arranged thereon.

The hybrid transmission device 3 includes a single countershaft 40 for connection to a differential 38 and to form the gear stages or gear steps. Two engagement devices S2, S3 with gearshift clutches A, B, C, D, including a first gearshift clutch A, a second gearshift clutch B, a third gearshift clutch C, and a fourth gearshift clutch D, are arranged on the countershaft 40 for connecting the idler gears 42, 44, 46, 48 to the countershaft 40. The countershaft 40 is free of fixed gear-step gears, i.e., no fixed gears of a gear step are located thereon. Only the one fixed gear 50 for connecting the differential 38 is provided as a fixed gear on the countershaft 40. The assignment of the fixed gears and the idler gears to the gear steps results on the basis of the gear step numbers G1, G2, G3, G4 below the gearwheels arranged on the countershaft 40.

On the basis of this scheme, the following is determined with respect to the gear steps: one fixed gear and one idler gear, particularly a single fixed gear and a single idler gear, are associated with each gear step G1, G2, G3, G4 and. Each pair of fixed gear and idler gear is always unambiguously associated with a single, respective gear step, i.e., there are no winding-path gears by utilizing one gearwheel of multiple gear steps. Nevertheless, the first and third gear steps G1, G3 are considered to be coupling gears, since the first transmission input shaft 12 is interconnected during the formation of the first and third gear steps G1, G3.

The electric motor EM2 is connected at an axially external gearwheel 16. As a result, it is possible to connect the electric motor EM2 without an additional gearwheel on the transmission input shaft 14, which saves installation space. In particular, due to the connection of the electric motor EM2 at the axially external gearwheel 16, an extremely axially short hybrid transmission device 3 is created. In some example embodiments, a chain or a further gearwheel for bridging the gap is utilized between the gearwheels 16 and 54.

The electric motor EM2, particularly its longitudinal axis A4, is arranged in parallel to the transmission input shaft 12.

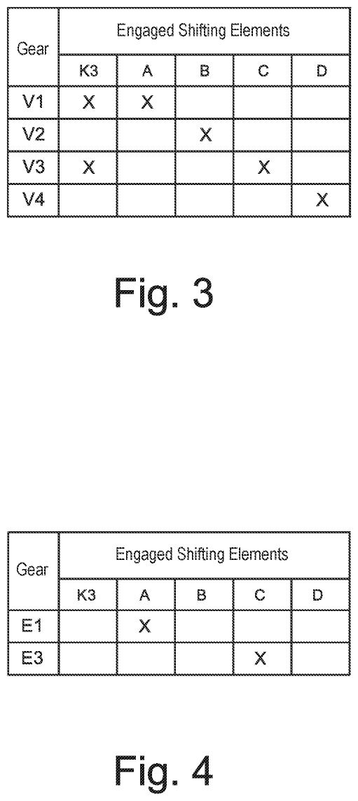

FIG. 3 shows a first example gear shift matrix for the hybrid transmission device 3 according to FIG. 2, in which it is apparent that four internal-combustion-engine gears, including a first internal-combustion-engine gear V1, a second internal-combustion-engine gear V2, a third internal-combustion-engine gear V3, and a fourth internal-combustion-engine gear V4 are implemented. In contrast to a typical dual-clutch transmission, in which clutches are alternately disengaged and engaged during the shifting of the forward gears, the odd internal-combustion-engine gears V1, V3 are implemented when the connecting clutch K3 is engaged and the even internal-combustion-engine gears V2, V4 are implemented when the connecting clutch K3 is disengaged. A changeover between the sub-transmissions therefore preferably takes place via the disengagement and engagement of the connecting clutch K3. In contrast to typical dual clutch transmissions, the utilization of the clutch is therefore implemented in a deviating manner. As is already also apparent from FIG. 2, precisely one of the gearshift clutches A, B, C, D is engaged and in the power flow in each of the internal-combustion-engine gears V1, V2, V3, V4.

FIG. 4 shows a second gear shift matrix for the hybrid transmission device 3 according to FIG. 2, in which electric gears, including a first electric gear E1 and a second electric gear E3, are indicated. Only the second transmission input shaft 14 and the engagement device S2 are utilized with one of the first and third gearshift clutches A, C. The second and fourth gear steps G2, G4 are therefore utilized only with the internal combustion engine and not with the electric motor EM2. The nomenclature results due to the association with the gear steps G1, G2, G3, G4.

FIG. 5 shows a transmission device 56 similar to the hybrid transmission device 3 according to FIG. 2, including a gear change transmission 58, wherein the only difference in FIG. 5 from FIG. 2 is that the sub-transmissions 28 and 30 are mirrored about the axis of symmetry 36. The connecting clutch K3, which does not belong to only one sub-transmission, the internal combustion engine 2, the gearwheel 50 for connecting the differential 38, and the differential 38 were not mirrored. Similarly, the electric motor EM2 remained connected to the fixed gear-step gear next to the connecting clutch K3, which is the gearwheel 34 of the gear step G4 in FIG. 5. Identical reference characters label identical components, i.e., the fixed gear 16 is still the fixed gear of the third gear step G3. Reference is therefore made to FIG. 2 for the explanation of the gear change transmission 56 according to FIG. 5.

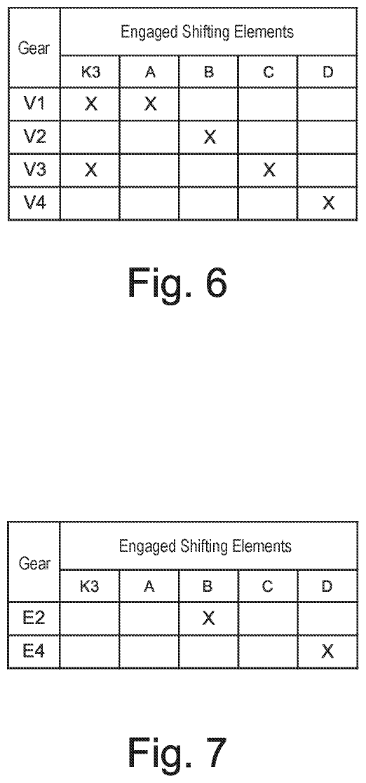

FIGS. 6 and 7 show gear shift matrices for the hybrid transmission 56, wherein FIG. 6 and FIG. 3 are identical. This is due to the mirroring about the axis of symmetry 36. FIG. 7, however, is different from FIG. 4 in that a third electric gear E2 and a fourth electric gear E4 are now implemented. This is due to the fact that the position of the electric motor EM2 was not also mirrored. Instead, the connection now takes place at the sub-transmission 30 with the even gear steps G2, G4.

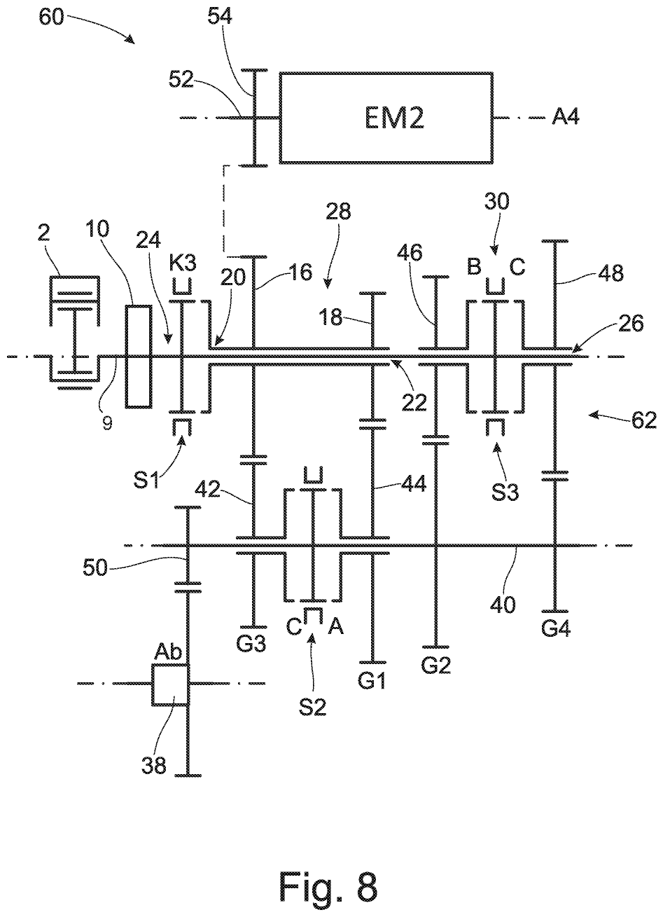

FIG. 8 shows a further modification of a hybrid transmission device 60, which differs from the hybrid transmission device 3 of FIG. 2 only with respect to the gear change transmission 62. In this case as well, identical reference characters indicate identical objects. Therefore, reference is largely made to FIG. 2 with respect to the description of the gear change transmission 62 and the hybrid transmission device 60. In contrast to the hybrid transmission device 3 according to FIG. 2, only the fixed gears 32, 34 have been moved from the first transmission input shaft 12 onto the countershaft 40 in FIG. 8, which is why the idler gears 46, 48 as well as the associated engagement device S3 are on the first transmission input shaft 12.

Since the re-positioning of the fixed gears and idler gears of the sub-transmission 30 resulted in no further changes, the gear shift matrices from FIGS. 3 and 4 apply for the hybrid transmission device 60.

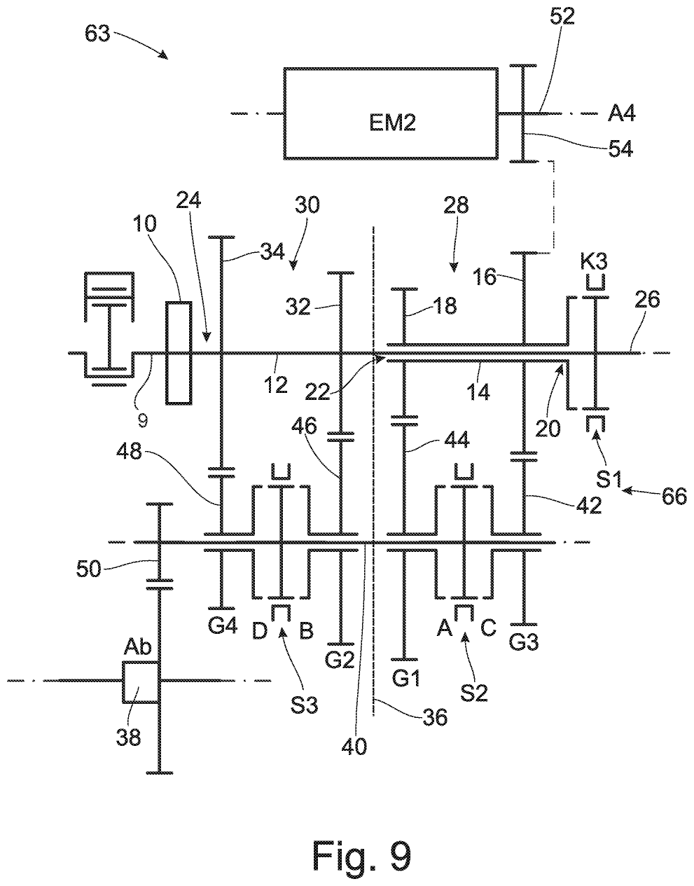

FIG. 9 shows a fourth embodiment of a hybrid transmission device 64 including a gear change transmission 66. Starting from the hybrid transmission device 3 from FIG. 2, the engagement devices S2 and S3, the idler gears, the fixed gears, the engagement device S1 including the connecting clutch K3, and the electric motor EM2 are mirrored about the axis of symmetry 36 when compared to FIG. 2. Therefore, the gear shift matrices from FIGS. 3 and 4 also apply for the hybrid transmission device 64 of FIG. 9.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 control device
5 hybrid drive train
6 electric axle
7 front axle
8 gear change transmission
9 crankshaft
10 damping device
12 first transmission input shaft
14 second transmission input shaft
16 fixed gear
18 fixed gear
20 end
22 end
24 end
26 end
28 sub-transmission
30 sub-transmission
32 fixed gear
34 fixed gear
36 axis of symmetry
38 differential
40 countershaft
42 idler gear
44 idler gear
46 idler gear
48 idler gear
50 fixed gear
52 output shaft
54 gearwheel
56 hybrid transmission device
58 gear change transmission
60 hybrid transmission device
62 gear change transmission
64 hybrid transmission device
66 gear change transmission
K3 connecting clutch
S1 engagement device
S2 engagement device
S3 engagement device
A first gearshift clutch
B second gearshift clutch
C third gearshift clutch
D fourth gearshift clutch
E fifth gearshift clutch
EM2 electric motor
A1 axis
A2 axis
A3 axis
A4 axis

1-15: (canceled)

16. A hybrid transmission device (3, 56, 60, 64), comprising:
a first transmission input shaft (12);
a second transmission input shaft (14) mounted on the first transmission input shaft;
at least one drive device (EM2); and
precisely one connecting clutch (K3), the connecting clutch (K3) selectively rotationally fixing the first transmission input shaft (12) to the second transmission input shaft (14).

17. The hybrid transmission device of claim 16, wherein the second transmission input shaft (14) extends between a first end (20) and a second end (22),
wherein the connecting clutch (K3) is proximate the first end (20) of the second transmission input shaft (14).

18. The hybrid transmission device of claim 17, wherein the first end (20) of the second transmission input shaft (14) is proximate an outer side of the hybrid transmission device (3, 56, 60, 64) and the second end (22) of the second transmission input shaft (14) is proximate an inner side of the hybrid transmission device (3, 56, 60, 64).

19. The hybrid transmission device of claim 17, wherein the connecting clutch (K3) is proximate the first end (20) of the second transmission input shaft (14).

20. The hybrid transmission device of claim 16, wherein the connecting clutch (K3) is a single shift element (S1).

21. The hybrid transmission device of claim 16, further comprising a plurality of gearshift clutches (A, B, C, D),
wherein one or more of the connecting clutch (K3) and the plurality of gearshift clutches (A, B, C, D) is a dog clutch.

22. The hybrid transmission device of claim 21, wherein each of the connecting clutch (K3) and the plurality of gearshift clutches (A, B, C, D) is a dog clutch.

23. The hybrid transmission device of claim 16, further comprising precisely one drive device (EM2), the drive device (EM2) being associated exclusively with the second transmission input shaft (14).

24. The hybrid transmission device of claim 23, wherein the drive device (EM2) is connected to a fixed gear (16) of a gear step.

25. The hybrid transmission device of claim 16, further comprising precisely two two-sided engagement devices (S2, S3) for producing four internal-combustion-engine gears (V1, V2, V3, V4).

26. The hybrid transmission device of claim 16, wherein the connecting clutch (K3) is mounted on the first transmission input shaft (12).

27. The hybrid transmission device of claim 16, wherein at least one of the first transmission input shaft (12) or the second transmission input shaft (14) is without a gearshift clutch.

28. The hybrid transmission device of claim 16, further comprising precisely one countershaft (40).

29. The hybrid transmission device of claim 28, further comprising precisely two, engagement devices (S2, S3) on the countershaft (40).

30. The hybrid transmission device of claim 16, further comprising a damping device (10), the first transmission input shaft (12) being directly connected or connectable to a crankshaft (9) of an internal combustion engine (2) via the damping device (10).

31. The hybrid transmission device of claim 16, further comprising axially external gear-step gears (16, 34) on an axis (A1) of the first and the second transmission input shafts (12, 14), at least one of the axially external gear-step gears being a fixed gear.

32. A motor vehicle (1) comprising the hybrid transmission device of claim 16.
